(19) United States
(12) Patent Application Publication
(10) Pub. No.: US 2023/0145617 A1
(43) Pub. Date: May 11, 2023

(54) CONTROL SYSTEM OF ELECTRIC BICYCLE

(71) Applicant: INEN INC., Taichung City (TW)

(72) Inventor: SHIH-TI LIN, Taichung City (TW)

(21) Appl. No.: 17/745,775

(22) Filed: May 16, 2022

(30) Foreign Application Priority Data
Nov. 5, 2021 (TW) 110141255

(51) Int. Cl. B62M 6/50; B62J 45/20; B62J 45/412; B62J 45/411; B62J 45/415; B62J 45/416

(52) U.S. Cl. CPC B62M 6/50; B62J 45/20; B62J 45/412; B62J 45/411; B62J 45/4152; B62J 45/416; B62J 50/22

(57) ABSTRACT

A control system of an electric bicycle includes is provided, including: a driving motor, a database and a control module. The driving motor includes a transmission module and at least one first sensor configured to sense at least one dynamic parameter of the transmission module. The database stores a plurality of riding mode information which respectively include a plurality of simulation parameters. The control module includes a setting unit, a computing unit and a control unit. The setting unit is configured to input at least one setting parameter, and the computing unit calculates a simulated moment of inertia and a calculation result data related to the simulated moment of inertia. The computing unit outputs at least one control signal according to the calculation result data, and the control unit receives the at least one control signal and controls a driving state of the driving motor accordingly.

### BACKGROUND OF THE INVENTION

### Field of the Invention

The present invention relates to a control system of an electric bicycle.

### Description of the Prior Art

With the popularity of sports, bicycles are not only used for transportation, but also an important item in leisure entertainments or sports competitions. Various types of bicycles have been developed, such as road bicycles, mountain bikes, electric bicycles and folding bikes, to meet different requirements, and some of the bicycles can be used with a bike trainer for riding training in a fixed location.

However, the use of a conventional bicycle is limited by weather, which is dangerous when the bicycle is ridden outdoor in bad weather. If the rider wants to ride a specific route (such as a hiking trail or any bike trail), the rider has to transport the bicycle to the destination first, which is inconvenient, wasting time and labor-consumption. In addition, a conventional electric bicycle with a bike trainer provides training effects by motors or magnetic resistance without consideration to weights of wheels and the rider, wind resistance, a friction between the wheel and the ground, a moment of inertia and other environmental factors in real riding, which results in a great difference in riding experience between simulated riding and real riding.

The present invention is, therefore, arisen to obviate or at least mitigate the above-mentioned disadvantages.

### SUMMARY OF THE INVENTION

The main object of the present invention is to provide a control system of an electric bicycle, which provides a riding experience close to real riding and riding conditions adjustable to meet various requirements.

To achieve the above and other objects, the present invention provides a control system of an electric bicycle, including: a driving motor, a database and a control module. The driving motor includes a transmission module and at least one first sensor configured to sense at least one dynamic parameter of the transmission module, and the transmission module is configured to be co-movably connected with a driving mechanism of the electric bicycle. The database stores a plurality of riding mode information which respectively include a plurality of simulation parameters. The control module includes a setting unit, a computing unit communicated with the database and the setting unit, and a control unit communicated with the computing unit. The setting unit is configured to input at least one setting parameter, and the computing unit calculates a simulated moment of inertia and a calculation result data related to the simulated moment of inertia according to the at least one setting parameter, the at least one dynamic parameter and the plurality of simulation parameters. The computing unit outputs at least one control signal according to the calculation result data, and the control unit receives the at least one control signal and controls a driving state of the driving motor accordingly.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a schematic diagram showing arrangement of a preferable embodiment of the present invention; and

FIG. 2 is block diagram of a preferable embodiment of the present invention.

### DETAILED DESCRIPTION OF THE PREFERRED EMBODIMENTS

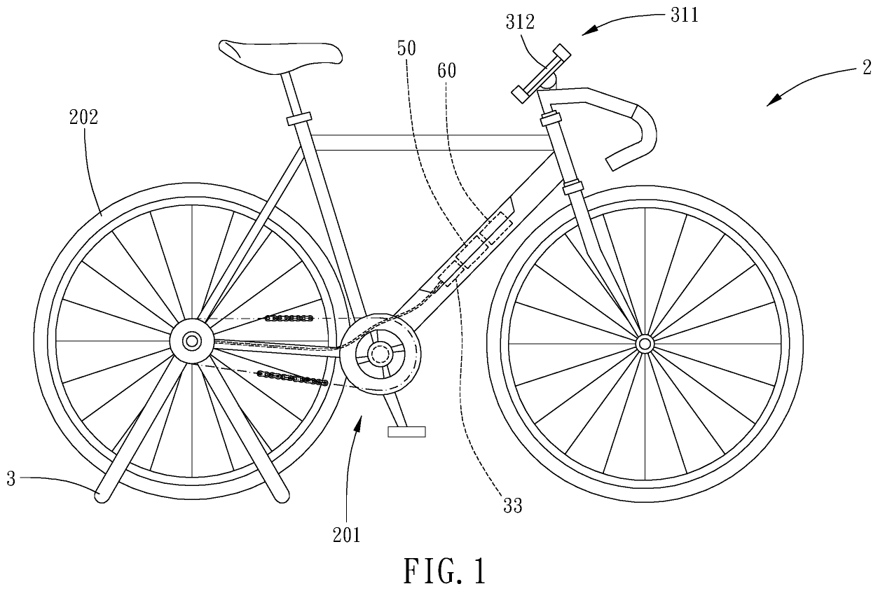

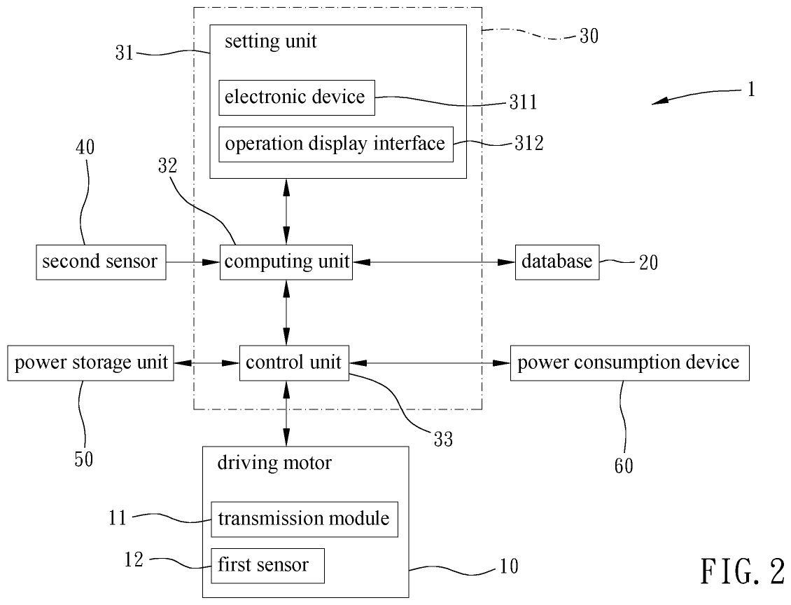

Please refer to FIGS. 1 to 2 for a preferable embodiment of the present invention. A control system 1 of an electric bicycle 2 of the present invention includes a driving motor 10, a database 20 and a control module 30.

The driving motor 10 includes a transmission module 11 and at least one first sensor 12 configured to sense at least one dynamic parameter of the transmission module 11, and the transmission module 11 is configured to be co-movably connected with a driving mechanism 201 of the electric bicycle 2. The database 20 stores a plurality of riding mode information which respectively include a plurality of simulation parameters. The control module 30 includes a setting unit 31, a computing unit 32 communicated with the database 20 and the setting unit 31, and a control unit 33 communicated with the computing unit 32. The setting unit 31 is configured to input at least one setting parameter, and the computing unit 32 calculates a simulated moment of inertia and a calculation result data related to the simulated moment of inertia according to the at least one setting parameter, the at least one dynamic parameter and the plurality of simulation parameters. The computing unit 32 outputs at least one control signal according to the calculation result data, and the control unit 33 receives the at least one control signal and controls a driving state of the driving motor 10 accordingly. Therefore, the control system 1 of the electric bicycle 2 can simulate an operation state of the electric bicycle 2 during being riding according to one of the plurality of riding mode information and control the driving motor 10 to provide resistance or assistance to the driving mechanism 201, which provides a riding experience close to real riding and riding conditions adjustable to meet various requirements.

The at least one first sensor 12 includes at least one of a speed sensor and a torque sensor so as to sense driving force from the driving mechanism 201 to the driving motor 10 during riding so that the computing unit 32 can calculate integrally in real time. For example, the at least one first sensor 12 may be used to sense a pedaling frequency or a pedaling strength of the driving mechanism 201. In this embodiment, the driving motor 10 is an external rotor permanent magnet synchronous motor assembled to a rear wheel 202 of the electric bicycle 2 by a standard quick-release mandrel, which is convenient to be assembled with a bike trainer 3 to ride the electric bicycle 2 in a fixed location. In this embodiment, the driving motor 10 is assembled to the rear wheel 202 and is co-movably connected with the driving mechanism 201, and a moment of inertia of the rear wheel 202 is not considered during operation, which does not correspond to a real riding condition. Therefore, the control system 1 of the electric bicycle 2 has to consider a dimension of the rear wheel 202, a weight of a rider, a weight of the electric bicycle 2 and other parameters to calculate the simulated moment of inertia so that the driving motor 10 can generate resistance or assistance to the driving mechanism 201 so as to realistically simulate various road conditions and provide various riding experience. In other embodiments, the driving motor may be disposed on a bottom bracket of the electric bicycle.

The plurality of riding mode information includes at least one of a cartographic information, a vehicle type information, a weather information and a training course information; the plurality of simulation parameters includes at least one of a distance data, a vehicle specification data, a route data and a slope data of the cartographic information, a wind resistance data and a simulated load data. The rider can select at least one of the plurality of riding mode information from the database 20 by the setting unit 31, such as riding routes, types of the bicycle (mountain bike, road bike, folding bicycle, etc.) and weather conditions (strong wind, no wind, etc.), and the computing unit 32 instantly calculates resistance or assistance that the driving motor 10 should provide to the driving mechanism 201 at different time points accordingly so as to provide a riding experience as expected. The rider may select one of said training course information by the setting unit 31 and ride the electric bicycle 2 with the bike trainer 3 so that the electric bicycle 2 can be used as an exercise bike and provides different training effects.

Preferably, the control system 1 of the electric bicycle 2 further includes at least one second sensor 40 communicated with the computing unit 32. The at least one second sensor 40 is configured to be disposed on the electric bicycle 2 and includes at least one of a cadence sensor, a torque sensor, a grade sensor, an attitude sensor and a tire pressure sensor. Therefore, when the rider is riding, the at least one second sensor 40 is configured to instantly sense a pedaling frequency of the rider, changes in force exerted by the rider on the driving mechanism 201, friction between the wheel of the electric bicycle 2 and the ground, or an inertial force of the wheel, and the computing unit 32 can calculate gradient resistance of roads, the moment of inertia, rotation variations of the rear wheel 202, friction resistance, or the like, which allows accurately integrate and estimate the torque that the driving motor 10 should provide.

Specifically, the computing unit 32 may calculate resistance or assistance that the driving motor 10 should provide under each of set conditions according to a relation (1) between a mass and a moment of inertia and a motor motion equation (2) as listed below:

$$m \times \frac{{v}^{2}}{{ω}^{2}} = I \qquad ( 1 )$$

$$T = TL + B ω + J \frac{dw}{dt} \qquad ( 2 )$$

Wherein m is a sum of the weight of the rider and the weight of the electric bicycle 2 and is obtained from the setting unit 31 (inputted by the rider) or the database 20; v is a rate of the electric bicycle 2 which is obtained from the at least one first sensor 12; ω is an angular velocity of the rear wheel 202 and is obtained from the at least one first sensor 12; I is a moment of inertia of the rear wheel 202; TL is assistance or a resistance caused by the slope of the road and is obtained from the at least one second sensor 40 or the database 20; Bω may include at least one of a friction between the rear wheel 202 and the ground, wind resistance and other resistances from the environment and is obtained from the at least one second sensor 40 or the database 20; J is the simulated moment of inertia calculated from the equation (1); dw/dt is the rotation change of the rear wheel 202 and is obtained from the at least one first sensor 12 or the at least one second sensor 40; T is a torque required to be output by the driving motor 10 to drive the rear wheel 202. Therefore, the control system 1 of the electric bicycle 2 actually considers the plurality of setting parameters, force exerted by the rider on the driving mechanism 201, environmental resistances, friction between the electric bicycle 2 and the ground, the moment of inertia of the rear wheel 202 and other factors, and controls the driving motor 10 to apply resistance or assistance to the driving mechanism 201 accordingly so that the rider can have expected riding experience.

The control system 1 of the electric bicycle 2 further includes a power storage unit 50 electrically connected with the control unit 33. The control unit 33 controls the power storage unit 50 to supply power to the driving motor 10 or controls the power storage unit 50 to store an electrical energy which is converted from a kinetic energy generated by the driving motor 10 so as to increase power supply for good durability of the electric bicycle 2. The control system 1 of the electric bicycle 2 further includes a power consumption device 60 electrically connected with the control unit 33. When an electric quantity of the power storage unit 50 is larger than or equal to a maximum electric quantity of the power storage unit 50 or when an instantaneous electric energy generated by the driving motor 10 is larger than a predetermined electric energy, the control unit 33 transmits an electric energy generated by the driving motor 10 to the power consumption device 60, which protects the power storage unit 50 from electric overload due to excessive instantaneous electric energy and maintains an output resistance of the driving motor 10 so as to have good durability of the power storage unit 50. For example, the power consumption device 60 may be connected with the control unit 33 by a conducting wire and includes at least one of a battery and an electro-thermal conversion device. The battery is configured to store excess electrical energy to increase the electrical quantity and charge external electronic devices, and the electro-thermal conversion device (such as a heat dissipation resistor, a fan, etc.) can release excess energy in the form of heat dissipation. The conduction relationship between the driving motor 10, the power storage unit 50 and the power consumption device 60 may be controlled by electrical signals or mechanical switches.

Moreover, the setting unit 31 includes an electronic device 311, and the electronic device 311 includes an operation display interface 312 which is configured to be operated externally and is communicated with the database 20 and the computing unit 32. The electronic device 311 may be a phone, a tablet, a portable monitor, or the like and is configured to be assembled to a top tube or a stem of the electric bicycle 2 so as to be convenient to view and operate. The operation display interface 312 displays at least one of the at least one dynamic parameter, a riding data information, the electric quantity, the at least one setting parameter and one of the plurality of riding mode information which is set, so that the rider check at any time to confirm the setting and operation status of the electric bicycle 2. The at least one setting parameter includes at least one of a weight of the rider, a weight of the electric bicycle 2 and a diametrical dimension of a wheel of the electric bicycle 2. The at least one setting parameter can be input by the rider through the operation display interface 312 or be obtained from the default data in the database 20 for calculation. Preferably, the database 20 is a cloud database which is convenient to access and update. In other embodiments, the database may be a storage unit configured to be disposed on the electric bicycle.

In summary, the control system of the electric bicycle can provides a simulation of riding conditions according to the rider setting, and the computing unit can perform the integrated calculation of the actual riding conditions and the setting conditions of the rider, which provides a riding experience close to real riding and is adjustable to meet various requirements in the riding experience. In addition, the electric bicycle can be used in a fixed location or for mobile riding, which is not limited by weather conditions and is convenient to use.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A control system of an electric bicycle, including:
a driving motor, including a transmission module and at least one first sensor configured to sense at least one dynamic parameter of the transmission module, the transmission module configured to be co-movably connected with a driving mechanism of the electric bicycle;
a database, storing a plurality of riding mode information which respectively include a plurality of simulation parameters; and
a control module, including a setting unit, a computing unit communicated with the database and the setting unit and a control unit communicated with the computing unit, the setting unit configured to input at least one setting parameter, the computing unit calculating a simulated moment of inertia and a calculation result data related to the simulated moment of inertia according to the at least one setting parameter, the at least one dynamic parameter and the plurality of simulation parameters, the computing unit outputting at least one control signal according to the calculation result data, the control unit receiving the at least one control signal and controlling a driving state of the driving motor accordingly.

2. The control system of the electric bicycle of claim 1, wherein the at least one first sensor includes at least one of a speed sensor and a torque sensor.

3. The control system of the electric bicycle of claim 1, further including at least one second sensor communicated with the computing unit, wherein the at least one second sensor is configured to be disposed on the electric bicycle and includes at least one of a cadence sensor, a torque sensor, a grade sensor and a tire pressure sensor.

4. The control system of the electric bicycle of claim 1, wherein the setting unit includes an electronic device, the electronic device includes an operation display interface which is configured to be operated externally and is communicated with the database and the computing unit.

5. The control system of the electric bicycle of claim 1, wherein the at least one setting parameter includes at least one of a weight of a rider, a weight of the electric bicycle and a diametrical dimension of a wheel of the electric bicycle.

6. The control system of the electric bicycle of claim 1, wherein the plurality of riding mode information includes at least one of a cartographic information, a vehicle type information, a weather information and a training course information.

7. The control system of the electric bicycle of claim 6, wherein the plurality of simulation parameters includes at least one of a distance data, a vehicle specification data, a route data and a slope data of the cartographic information, a wind resistance data and a simulated load data.

8. The control system of the electric bicycle of claim 1, further including a power storage unit electrically connected with the control unit, wherein the control unit controls the power storage unit to supply power to the driving motor or controls the power storage unit to store an electrical energy which is converted from a kinetic energy generated by the driving motor.

9. The control system of the electric bicycle of claim 8, further including a power consumption device electrically connected with the control unit, wherein when an electric quantity of the power storage unit is larger than or equal to a maximum electric quantity of the power storage unit or when an instantaneous electric energy generated by the driving motor is larger than a predetermined electric energy, the control unit transmits an electric energy generated by the driving motor to the power consumption device.

10. The control system of the electric bicycle of claim 7, wherein the at least one first sensor includes at least one of a speed sensor and a torque sensor; the control system of the electric bicycle further includes at least one second sensor communicated with the computing unit, wherein the at least one second sensor is configured to be disposed on the electric bicycle and includes at least one of a cadence sensor, a torque sensor, a grade sensor and a tire pressure sensor; the setting unit includes an electronic device, the electronic device includes an operation display interface which is configured to be operated externally and is communicated with the database and the computing unit; the at least one setting parameter includes at least one of a weight of a rider, a weight of the electric bicycle and a diametrical dimension of a wheel of the electric bicycle; the control system of the electric bicycle further includes a power storage unit electrically connected with the control unit, the control unit controls the power storage unit to supply power to the driving motor or controls the power storage unit to store an electrical energy which is converted from a kinetic energy generated by the driving motor; the control system of the electric bicycle further includes a power consumption device electrically connected with the control unit, when an electric quantity of the power storage unit is larger than or equal to a maximum electric quantity of the power storage unit or when an instantaneous electric energy generated by the driving motor is larger than a predetermined electric energy, the control unit transmits an electric energy generated by the driving motor to the power consumption device; the power consumption device includes at least one of a battery and an electro-thermal conversion device; the database is a cloud database; the driving motor is an external rotor permanent magnet synchronous motor assembled to a rear wheel of the electric bicycle; and the operation display interface displays at least one of the at least one dynamic parameter, a riding data information, the electric quantity, the at least one setting parameter and one of the plurality of riding mode information which is set.
